(19) United States
(12) Patent Application Publication
(10) Pub. No.: US 2024/0354737 A1
(43) Pub. Date: Oct. 24, 2024

(54) PARKING MANAGEMENT SYSTEM

(71) Applicant: Dr. JUNG-TANG HUANG, TAIPEI (TW)

(72) Inventor: JUNG-TANG HUANG, TAIPEI (TW)

(21) Appl. No.: 18/137,241

(22) Filed: Apr. 20, 2023

(51) Int. Cl. G06Q 20/32; G06V 20/62; H04N 7/18

(52) U.S. Cl. CPC G06Q 20/3278; H04N 7/188; G06Q 2240/00

(57) ABSTRACT

The invention discloses an intelligent parking management system, which includes a license plate number detection device and a server; a first camera, and a second camera arranged side by side with the first camera, the first camera of the rear license plate number detection device obtains the rear license plate image when the vehicle is parked in the rear parking space, and the second camera of the front license plate number detection device obtains the front license plate image of the vehicle on the rear parking space, and upload the shooting time and shooting image to the server; the server receives the parking space image uploaded by the license plate number detection device, and simultaneously updates the rear parking space information and the corresponding database information, so that other car owners can judge the whether there is a car in the rear parking space. The invention can improve the convenience, timeliness and correctness of parking management.

### BACKGROUND OF THE INVENTION

### 1. Field of the Invention

The present invention relates to the technical field of parking, in particular to a parking management system.

### 2. Description of Related Art

The traditional charging for parking spaces is still in the stage of manual charging, and most of the on-street parking charges are still in the form of patrolling toll collectors arriving at the scene to issue bills. Therefore, the traditional parking space charging not only wastes manpower and material resources, but also is very inefficient. Most of the traditional parking fees and payment methods still place the payment slip on the vehicle in the parking compartment. When the car owner leaves the vehicle, he removes the payment slip and takes it to a toll collection agency at a specific location for payment, resulting in inconvenience to pay fees and increases the time cost.

The traditional query of parking spaces is mostly limited to large department stores, stores, or large parking lots, and its management system is still only able to inform the stage of the number of parking spaces. Knowing where there are vacant parking spaces leads to spending a lot of time detours to search for vacant parking spaces, which is quite inefficient in use.

### SUMMARY OF THE INVENTION

The present invention aims to solve one of the technical problems in the above-mentioned technologies at least to a certain extent. Therefore, the purpose of the present invention is to provide a parking management system, which can improve the convenience, timeliness and accuracy of on-street parking management.

In order to achieve the above object, the first embodiment of the present invention proposes a parking management system, including a license plate number detection device and a server;

A license plate number detection device, comprising at least one parking space sensor, a first camera and a second camera, and at least one wireless communication module; the installation method of the device in a roadside parking space: the first license plate number detection device and the second license plate number detection device is respectively arranged above the curb next to the Nth and (N+1)th parking spaces, and is 35-85 centimeters away from the grid line behind the corresponding parking spaces. When the sensor is triggered, the first camera of the second license plate number detection device is used to obtain the rear license plate image of the vehicle parked in the (N+1)th parking space. Further, through the notification of wireless communication, the second camera of the first license plate number detection device is used to obtain the image of the front license plate of the vehicle on the (N+1)th parking space, and wirelessly upload the shooting time and the shooting image to the server.

The server has a database of the Nth parking space information and the (N+1)th parking space information, and the server receives the parking space image uploaded by the license plate number detection device to determine whether there is a vehicle parked in the Nth parking space or the (N+1)th parking space, if there is one, record the license plate number of the vehicle on the parking space to record the parking time and departure time of the vehicle, and record the parking fee calculated according to the parking rate for the license plate number of the parking space. The parking fee is transmitted to the mobile device of the car owner through network communication, so that the mobile device of the car owner can make payment, and at the same time, the database information of the Nth parking space information and the (N+1)th parking space information is updated, so as to facilitate other car owners to judge whether there is a car in the Nth parking space and the (N+1)th parking space.

According to an on-street parking management system in the first embodiment of the present invention, since a first camera and a second camera arranged side by side with the first camera are set in the license plate number detection device, whether there is a car in the Nth parking space and the (N+1) parking space, and can record the parking time of the vehicle on the Nth parking space or the (N+1)th parking space, so as to facilitate the calculation of the parking fee and the payment of the car owner. At the same time, car owners can remotely connect to query parking information, such as parking space usage status, parking time, parking fees, etc. Therefore, the present invention can improve the convenience, timeliness and accuracy of on-street parking management.

In addition, according to the parking management system proposed by the above-mentioned embodiment of the present invention, it can also have the following additional technical features:

Further, the license plate number detection device is set to a plurality of, and each parking space is provided with a license plate number detection device, and an extra license plate number detection device is added at a distance 35-85 centimeters in front of the grid line of the first parking space.

Further, the height of the camera lens in the license plate number detection device is 10-30 cm above the ground.

Further, the license plate number detection device includes an upper cover, a base, a support frame, a wireless communication module, a parking space sensor, a first camera, a second camera, a battery, a solar panel and a processing module, and the upper cover is connected with the base, the support frame is arranged on the upper cover, the battery is connected to the solar panel, the solar panel is arranged between the support frame and the upper cover, and supplies power to the battery, the processing module is arranged between the support frame and the upper cover, and the processing module is connected to the parking space sensor, the wireless communication module, the first camera and the second camera.

Further, the lens detection angle of the first camera is 70-90 degrees; the lens detection angle of the second camera is 70-90 degrees.

Further, the license plate number detection device is arranged on the pile.

Further, the license plate number detection device is arranged on the top of the curb, and is 25-45 centimeters from the grid line behind the corresponding parking space, and the camera lens height in the license plate number detection device is 10-30 centimeters from the ground.

Further, the license plate number detection device has a communication function of Bluetooth, WIFI, LPWA, 3G, 4G or 5G, and can communicate with the car owner's mobile phone.

Further, the lens of the first camera and the lens of the second camera are a wide-angle lens, a standard lens, an ultra-wide-angle lens or a fisheye lens.

Further, the server is a cloud server or an area server.

In order to achieve the above object, the second embodiment of the present invention proposes a parking management system, including a license plate number detection device, an in-ground parking sensor, and a server.

The license plate number detection device includes a first camera and a second camera, and at least one wireless communication module; the in-ground parking sensor is arranged in the middle of the (N+1)th parking space; the license plate number detection device Installation method in roadside parking spaces: the first license plate number detection device and the second license plate number detection device are respectively installed on the top of the curb next to the Nth and (N+1) parking spaces. When the sensor is triggered, the first camera of the second license plate number detection device is used to obtain the rear license plate image of the vehicle parked in the (N+1)th parking space, and the second camera of the first license plate number detection device is used to obtain the image of the front license plate of the vehicle on the (N+1) parking space, and wirelessly upload the shooting time and shooting image to the server.

The server has a database of the Nth parking space information and the (N+1)th parking space information, and the server receives the parking space image uploaded by the license plate number detection device to determine whether there is a vehicle parked in the Nth parking space or the (N+1)th parking space, if there is one, record the license plate number of the vehicle on the parking space to record the parking time and departure time of the vehicle, and record the parking fee calculated according to the parking rate for the license plate number of the parking space. The parking fee is transmitted to the mobile device of the car owner through network communication, so that the mobile device of the car owner can make payment, and at the same time, the database information of the Nth parking space information and the (N+1)th parking space information is updated, so as to facilitate other car owners to judge whether there is a car in the Nth parking space and the (N+1)th parking space.

According to a parking management system of the second embodiment of the present invention, since the first camera is set in the license plate number detection device, it can instantly detect whether there is a car in the Nth parking space and the (N+1)th parking space, and the parking time of the vehicle on the Nth parking space or the (N+1)th parking space is recorded, so as to facilitate the calculation of the parking fee and facilitate the payment of the vehicle owner. At the same time, car owners can remotely connect to query parking information, such as parking space usage status, parking time, parking fees, etc. Therefore, the present invention can improve the convenience, timeliness and accuracy of on-street parking management.

In addition, according to the parking management system proposed by the second embodiment of the present invention, it can also have the following additional technical features:

Further, the license plate number detection device comprises an upper cover, a base, a support frame, a wireless communication module, a first camera, a second camera, a battery, a solar panel and a processing module, the upper cover is connected with the base, and the support frame is arranged on the upper cover on the top, the battery is connected with the solar panel, the solar panel is arranged between the support frame and the upper cover, and supplies power to the battery, the processing module is arranged between the support frame and the upper cover, the processing module is connected with the wireless communication module, the first camera and the second camera.

Further, the in-ground parking sensor is used to detect the occupied space or vacant space of the vehicle compartment, and accordingly notify the first camera of the second license plate number detection device through the wireless signal to obtain the rear license plate image of the vehicle when the vehicle is reversing into the (N+1) parking space, and the second camera of the first license plate number detection device obtains the front license plate image of the vehicle on the (N+1)th parking space, and uploads the shooting time and shooting image to the server; the parking space sensor includes an upper cover, a base, a support frame, a geomagnetic sensor, a wireless communication module, a battery, a solar panel and a processing module. The upper cover is connected with the base, the support frame is arranged on the upper cover, and the battery is connected with the solar panel. The solar panel is arranged between the support frame and the upper cover, and supplies power to the battery, the processing module is arranged between the support frame and the upper cover, and the processing module is connected with the geomagnetic sensor and the wireless communication module.

Further, the license plate number detection device has a communication function of Bluetooth, WIFI, LPWA, 3G, 4G or 5G, and can communicate with the car owner's mobile phone.

Further, the license plate number detection device is arranged on the top of the curb, and the distance from the grid line behind the corresponding parking grid is 35-85 centimeters, and the camera lens height in the license plate number detection device is 10-30 centimeters from the ground.

In the above-mentioned first and second embodiments, if there is no curb on the side of the road, the bottom of the license plate number detection device can also be raised about the height of the curb, and it is still firmly arranged on the roadside. The distance between the grid lines behind the parking space is 35-85 centimeters, and the height of the camera lens in the license plate number detection device is 10-30 centimeters above the ground.

In order to achieve the above object, the third embodiment of the present invention proposes a parking management system, which is characterized in that: it includes a license plate number detection device and a server; the license plate number detection device includes a first camera and a second camera, at least one wireless communication module; the installation method of the license plate number detection device in an open parking lot, a gateless parking lot, or a small parking lot: the license plate number detection device is installed on the wall or surrounding and at the middle of every 4 parking spaces. The device is set above the parapet with a height similar to the curb, so that the first camera can shoot the two parking spaces on the left, and the second camera can shoot the two parking spaces on the right, and the four parking spaces are shot at regular intervals. The license plate images of the parked vehicles in each grid, and the shooting time and the shooting images are wirelessly uploaded to the server; the server has a database of the four-parking grid information, and the server receives the parking space images uploaded by the license plate number detection device to determine whether there is a parking space. The vehicle is parked in the four parking spaces, and if there is any, the license plate number of the vehicle on the parking space is recorded, further to record the parking time and departure time of the vehicle, and the parking fee for the license plate number of the parking space is calculated according to the parking rate. The parking fee is transmitted to the mobile device of the car owner through network communication, so that the mobile device of the car owner can make payment, and the database information of the information of the four parking spaces is updated at the same time, so that other car owners can judge whether there is a car in the four parking spaces.

### BRIEF DESCRIPTION OF THE DRAWINGS

FIG. 1 is the structural representation of the roadside parking management system that the license plate number detection device according to the embodiment of the present invention is installed on the curbstone;

FIG. 2 is a schematic diagram of the external and internal structures of a license plate number detection device according to an embodiment of the present invention;

FIG. 3 is a schematic structural diagram of a processing module according to an embodiment of the present invention;

FIG. 4 is the structural representation that the license plate number detection device according to the embodiment of the present invention is installed on the curb, and the vehicle reverses and enters the parking grid, and photographs the license plate after it;

FIG. 5 is the structural representation that the license plate number detection device according to the embodiment of the present invention is installed on the curbstone, the vehicle enters the parking grid, and photographs its front license plate;

FIG. 6 is the structural representation that the license plate number detection device according to another embodiment of the present invention is installed on a road along a stone;

FIG. 7 is a schematic structural diagram of an open parking lot management system in which the license plate number detection device according to an embodiment of the present invention is installed on a low wall.

### DESCRIPTION OF THE EMBODIMENTS

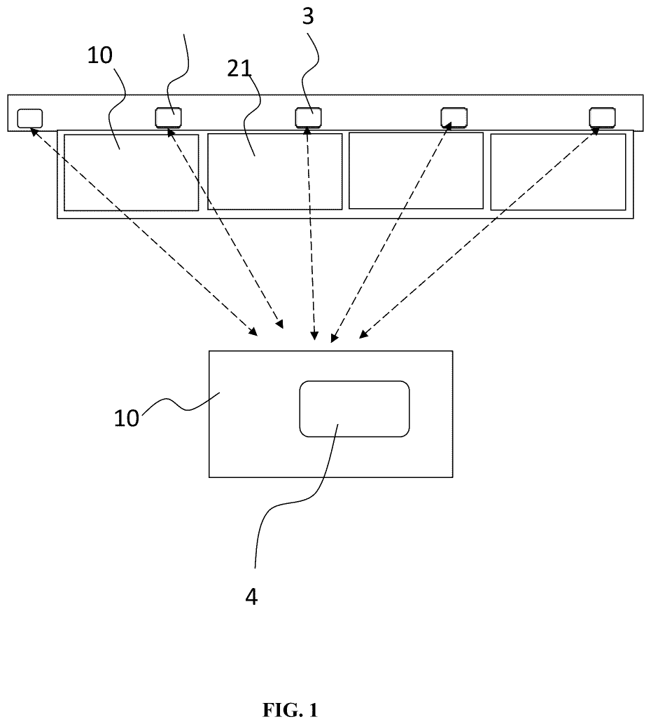

Embodiments of the present invention are described in detail below, examples of which are illustrated in the accompanying drawings, wherein the same or similar reference numerals refer to the same or similar elements or elements having the same or similar functions throughout. The embodiments described below with reference to the accompanying drawings are exemplary, and are intended to explain the present invention and should not be construed as limiting the present invention. As shown in FIG. 1 to FIG. 5, an on-street parking management system according to an embodiment of the present invention includes license plate number detection devices 101 and 102 and a server 2; the license plate number detection device 101 is provided with a first camera 1011 and a second camera arranged side by side with the first camera 1011 1012, the lens of the first camera 1011 is close to the second camera 1012, the second camera 1012 is used to detect the front license plate number of the vehicle on the second parking space 4, the lens of the first camera 1011 is close to the second camera 1012, the first camera 1011 used to detect the rear license plate number of the vehicle on the first parking space 3, the first camera 11 and the second camera 12 regularly detect the license plate number of the vehicle on the first parking space 3 and the second parking space 4, and the shoot time and shot images are uploaded to server 2.

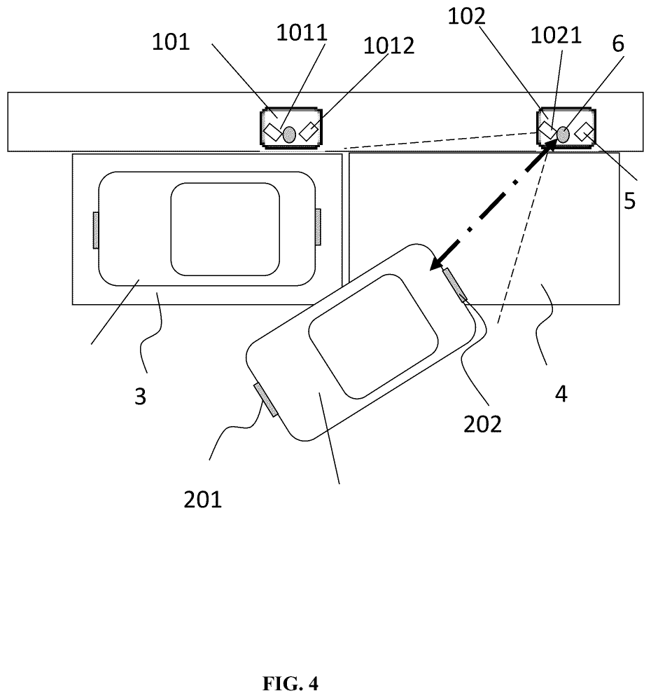

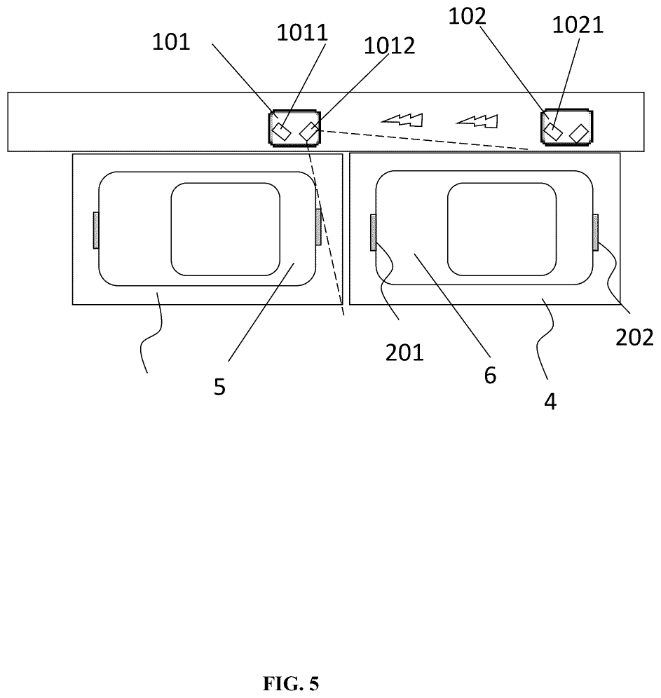

In this example, as shown in FIG. 4 and FIG. 5, the first license plate number detection device 101 and the second license plate number detection device 102 are respectively arranged on the road beside the first parking space 3 and the second parking space 4 on the top of the curbstone, and with a distance of 35-85 cm from the grid line behind the corresponding parking space, by the triggering of the parking space sensor 1023, the first camera 1021 of the second license plate number detection device 102 is used to obtain the image of the rear license plate 202 of the second vehicle 6 during reverse parking into the second parking space 4 as shown in FIG. 4; further as shown in FIG. 5, through the notification of wireless communication, the second camera 1012 of the first license plate number detection device 101 is used to obtain the image of the front license plate 201 of the second vehicle 6 on the second parking spaces 4. The shooting time and the shooting image are wirelessly uploaded to the server.

The server 2 has a database of the information of the first parking space 3 and the information of the second parking space 4, and the server 2 receives the parking space images uploaded by the license plate number detection devices 101 and 102 to determine whether there is a vehicle parked in the first parking space 3 or the second parking space 4, if there is one, record the license plate number of the vehicle on the parking space, and continuously record the parking time and departure time of the vehicle, and record the parking fee for the license plate number at the parking space calculated according to the parking rate. The parking fee is transmitted to the mobile device of the car owner through network communication, so that the mobile device of the car owner can make payment, and the database of the information of the first parking space 3 and the information of the second parking space 4 is updated to facilitate other car owners to judge whether there is a car in the first parking space 3 or the second parking space 4. The server 2 may be a cloud server or an area server.

Since the first camera 1011 and the second camera 1012 arranged side by side with the first camera 1011 are arranged in the license plate number detection device 101, the first camera 1021 is arranged in the vehicle number detection device 102 and the second camera 1022 arranged side by side with the first camera 1021 can instantly detect whether there are cars in the first parking space 3 and the second parking space 4, and can record the parking time of the vehicles on the first parking space 3 or the second parking space 4, so as to facilitate the calculation of parking fees, which is convenient for the car owner to pay the fee. At the same time, car owners can remotely connect to query parking information, such as parking space usage status, parking time, parking fees, etc. Therefore, the present invention can improve the convenience, timeliness and accuracy of on-street parking management.

Optionally, a plurality of license plate number detection devices are provided, each parking space is provided with a license plate number detection device, and a license plate number detection device is added on the grid line in front of the head end parking space.

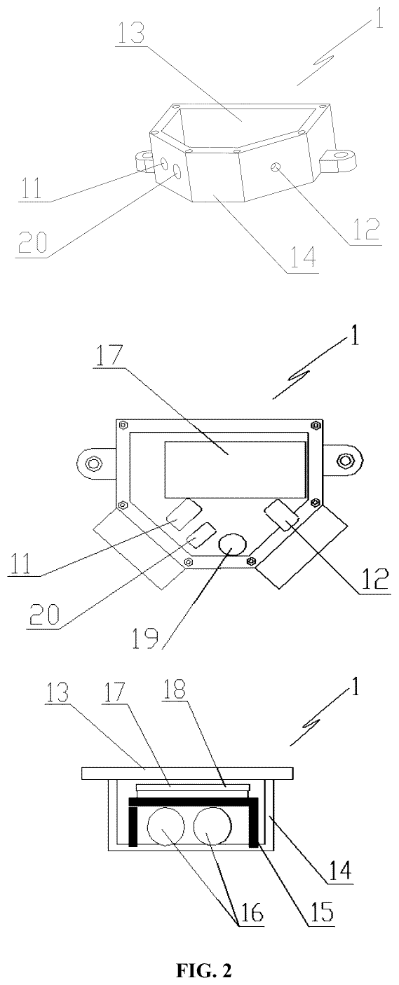

In this example, as shown in FIG. 2, the license plate number detection device 1 includes a transparent upper cover 13, a base 14, a support frame 15, a battery 16, a solar panel 17 and a processing module 18, and the upper cover 13 is connected with the base 14. The support frame 15 is arranged on the upper cover 13, the battery 16 is connected to the solar panel 17, the solar panel 17 is arranged between the support frame 15 and the upper cover 13, and supplies power to the battery 16, and the processing module 18 is arranged In between the support frame 15 and the upper cover 13. The processing module 18 is connected to the geomagnetic sensor 19, the ranging sensor 20, the first camera 11 and the second camera 12.

In order to prevent the outer casing in front of the lens from being covered by raindrops due to rain, and possibly being shielded by leaves, the transparent upper cover 13 can adopt an extended rain-proof cover.

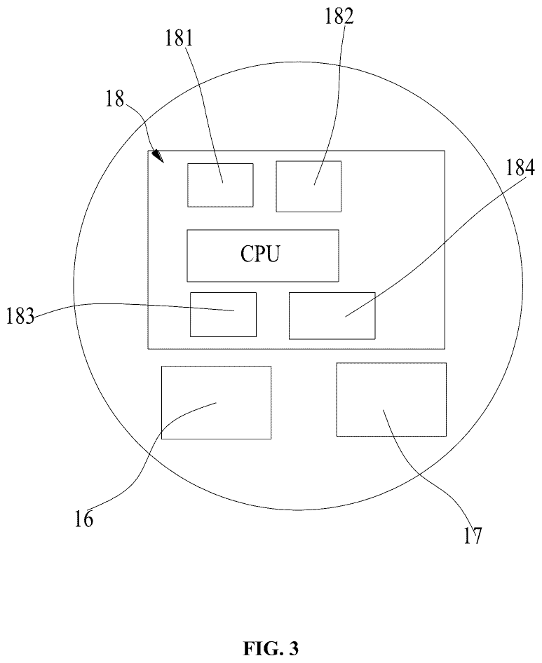

As shown in FIG. 3, the processing module 18 may include a processor CPU, an image capturing module 181, an identification module 182, a memory module 183 and a communication module 184. Among them, the processor CPU is electrically connected with the image capturing module 181, the image recognition module 182, the memory module 183 and the communication module 184 to control each module, perform arithmetic processing and transmit data. The structure and functions of each module is described as follows: the image capturing module 181 can be a generally known camera or photographing module, so its detailed structure will not be repeated here. The image capturing module 181 is employed to obtain image of the vehicle's license plate number.

The recognition module 182 can be a known image recognition module, or an edge computing AI chip, for example, it can perform pre-processing including image, detection and capture of target position, target area component cutting, target recognition processes such as feature extraction of object area components, but not limited to this; further, shadow processing, color conversion, equalization processing, etc. may be included to further improve the recognition rate. Further, it can also include image recognition (object classifiers such as SVM, Adaboost, Neural Network, PCA, Deep learning, etc. or OCR recognition algorithms) to directly recognize the license plate number, but the above recognition methods are already known art, and will not be described in detail here.

After the recognition is completed, the above image can be converted into the corresponding license plate information and parking space information, and then transmitted to the processor CPU, and the license plate information and the parking space information can be directly or indirectly transmitted to the memory module 183 through the processor CPU. The parking space information here refers to the position of the parking space where the parking space sensor is located, such as latitude and longitude, or latitude, longitude and altitude, which can be set directly using the map when installed in the parking space, and the number of the parking space can also be added.

In other embodiments, the recognition module 182 can also be integrated into the processor CPU, in other words, the processor itself has a built-in recognition function module.

In other derivative embodiments, the recognition module 182 can also be omitted, and a recognition module (not shown) is set in the server 2 instead, or a built-in recognition module is additionally set in the image processing server (not shown), the server 2 identifies by itself or the image processing server sends the identified information back to the server 2, so that it is not necessary to modify the existing roadside camera devices or need an additional installation of a new camera device with a built-in recognition module.

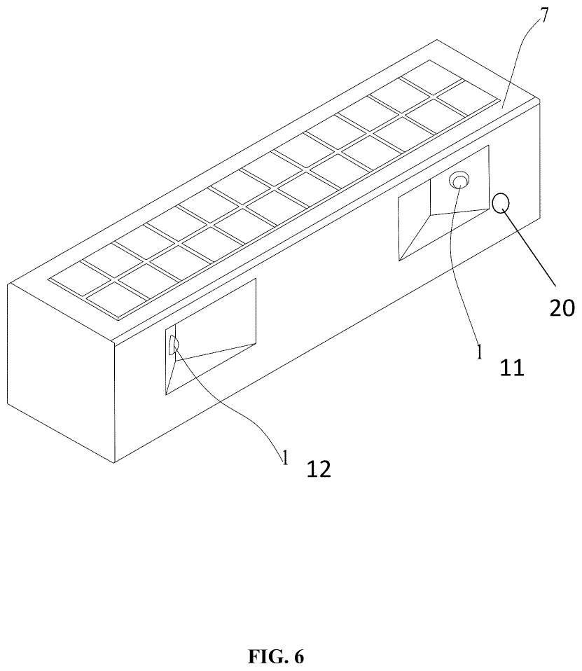

As an embodiment, as shown in FIG. 6, the license plate number detection device 1 can also be arranged on the cuboid 7, or curbstone like and its function is similar to that of FIG. 2, the difference is the setting positions of the first camera 11 and the second camera 12 are different, that is the left and right are reversed, and the distance measuring sensor 20 is still disposed adjacent to the first camera 11, and the manner of being installed on the curb is similar to that shown in FIG. 2. The first camera 11 and the second camera 12 can take pictures of the front and rear vehicle license plates respectively, and the operation method is the same as that in FIG. 2, and will not be repeated here. The camera lens angle of the license plate number before the first camera 11 and the second camera 12 can be adjusted according to on-site installation. In this example, the angle of the license plate after the first camera 11 is taken can be 10-60 degrees from the horizontal line. The angle of the license plate number can be 10-70 degrees from the horizontal.

In this example, it is possible to remotely control whether the license plate number detection device 1 is activated, and every fixed time, such as 3-5 minutes, the license plate number detection device 1 can be activated to detect the license plate number. As shown in FIG. 4 and FIG. 5, when the vehicle is parked, within 3-5 minutes, the license plate number detection device 1 will be activated to detect the license plate number.

Further, the license plate number detection devices 101 and 102 have the communication function of Bluetooth, WIFI, LPWA, 3G, 4G or 5G, and can communicate with the car owner's mobile phone.

In this example, the lens of the first camera 11 and the lens of the second camera 12 can be selected as standard lenses with a viewing angle between 55 degrees and −45 degrees, or wide-angle lenses with a viewing angle between 76 degrees and −64 degrees; or it is an ultra-wide-angle lens with a viewing angle between 110 degrees and −84 degrees.

In some embodiments, using the on-street parking management device of the present invention, the car owner does not need to download the APP, but only needs to enter the on-street parking management website to browse, inquire, make an appointment, and pay. The car owner parks in the car and can leave, and can choose to receive text messages at their own expense, or to check online for free, or to apply for automatic deduction. Enter the car number or ID card, the car owner can check the cost and can also reserve a parking space. As long as the reserved parking space is occupied, the car owner of the occupied parking space will receive a text message and be asked to park elsewhere, or the owner of the car will be recognized by the license plate and their parking fees will be charged at a punitively high rate.

In some embodiments, the APP can also be used to provide the following advantages: 1. As long as the car owner presses the button of the direct debit on the APP, he can enjoy the sub-billing and pay the account at a discount, and there is no need to go to the convenience store to pay the fee. There is also no need to get out of the car and pay at the POS machine. 2. It is easy to find the parked car, as long as the car owner opens the car owner APP, he can use GPS, because the mobile phone can locate itself, and at the same time display the map of the parking lot and the location of the car, so the car owner can operate navigation, in addition to GPS, plus each license plate detection device 1 broadcast information of latitude, longitude and altitude via Bluetooth, the car owner APP can clearly indicate the location of his parked car. In other embodiments, due to being installed on the curbstone or the ground, the license plate number detection device 1 uses a battery instead of the mains wiring to supply power. Therefore, in order to reduce power consumption, the recognition module 182 only performs image preprocessing, and the image of the license plate part is cropped and uploaded directly to the server 2, using manual recognition. For example, the image of the license plate part may fall in 100×50 pixels. If grayscale processing is used, after compression, the amount of data will only be 500 bytes, so it only needs to use low power wide area communication (LPWA), such as NB-IoT, CAT-M1, etc., it can upload to the cloud with low power consumption.

In some embodiments, the license plate number detection device can be further combined with other sensors such as infrared, ultrasonic, microwave, radar, LiDAR and other sensors with ranging functions, and a geomagnetic sensor. When the geomagnetic sensor of the license plate number detection device of the (N+1)th parking space does not detect enough steady-state geomagnetic value, it can be determined that there is no vehicle parked in the (N+1)th parking space. Sensors with distance functions such as ultrasonic sensors can detect every 5 seconds for one second, and the detection distance is about 2-3 meters, which can confirm whether there is a vehicle backing up and prepare to park. If there is, start the first camera to take pictures of the rear license plate of the parked vehicle, and stop the operation of the ultrasonic sensor at the same time. After parking, the geomagnetic sensor can detect that there is enough steady-state geomagnetic value, so it is determined that the car has been parked. Further, the second camera is activated through the Bluetooth connection to the license plate number detection device of the Nth parking space to take a photo of the front license plate of the vehicle parked in the (N+1) parking space.

For entering the vehicle without reversing, there is no way to know the timing of its entry, so it is impossible to effectively photograph the rear license plate, but once it is parked, the geomagnetic sensor of the second license plate number detection device can know that the vehicle has been parked, the second camera of the first license plate number detection device can be notified to shoot the front license plate of the parked vehicle.

In some embodiments, the management of on-street parking for heavy locomotives needs to be carried out. Although the locomotive does not need to reverse vehicle to enter the parking space, once the locomotive is parked in the parking space, the geomagnetic sensor cannot obtain effective changes to the geomagnetism at the parking space, therefore, the ultrasonic sensor will continue to launch search, and the parked heavy locomotive may trigger the ultrasonic wave. Therefore, let the first camera take pictures of the rear license plate of the parked vehicle. Therefore, it is very possible to obtain the rear license plate of the heavy locomotive. This method effectively solves the problem that the geomagnetic sensor is placed in the middle of the parking grid and is not easy to detect the locomotive, and the license plate is automatically photographed to obtain the license plate number of the heavy locomotive.

In some embodiments, additional parking space sensors such as geomagnetic, infrared, ultrasonic, microwave, radar waves, etc. may not be used for sensing, and only the second camera of the Nth parking space license plate number detection device may be used for photographing the front license plate of the vehicle in the second parking space at regular intervals, for example, every five minutes, a photo is taken, and then uploaded to the cloud for manual recognition or AI automatic recognition. In this way, there are two situations. The first situation is that the camera itself is a parking space sensor. Even if the casing is affected by dust and other factors, the license plate cannot be clearly identified, but it can still effectively identify whether a car is parked, and its color and shape can still be recognized. Therefore, the present embodiment may not need an additional parking space sensor. There may be a delay of up to five minutes in judging that the vehicle is parked, but it will not cause customer complaints. If the image cannot identify the license plate, it needs to send someone to shoot the license plate, and at the same time, the housing of the license plate number detector can be cleaned and excluded. The second situation is that the license plate is clearly identifiable, so log in and deduct money directly. The advantage of using a camera to shoot is to reduce the possibility of theft, because every five minutes of shooting, if there is a thief, the thief may also be photographed.

The purpose of the second camera 1012 of the license plate number detection device 101 and the first camera 1021 of the license plate number detection device 102 to simultaneously photograph the front and rear license plates of the vehicle parked in the parking space 4 is to avoid the inability to obtain license plate images because the position of the parked vehicle may be forward or backward, which will cause insufficient viewing angle of the camera installed on the ground, resulting in the failure to obtain the license plate image.

The two cameras photographing the same parking space have advantages: only have one camera that can identify the license plate number, and then compare the color and model to confirm the parked vehicle and the license plate number, and thereby determine the earliest time the car parked or left. Therefore, it is possible to charge by time, purely from the perspective of taking pictures as a deposit and inspection, and there will be no disputes. As for the fee for parking people, it is only 1.5-2.5 minutes less, and there will be no disputes.

In some embodiments, an in-ground parking space sensor is further installed in each parking space, that is, in FIG. 2, the camera 11 and camera 12 are removed from the license plate number detection device 1 containing the Bluetooth communication module as well as the ranging sensor 20, but add the geomagnetic sensor 19, and change the casings 13 and 14 into cylindrical shapes to facilitate embedding in the ground. Install this recessed parking space sensor in the middle of each parking space. When a vehicle reverses into the (N+1)th parking space, the geomagnetic value increases, and the embedded parking space sensor immediately starts the Bluetooth broadcast for a period of time, such as 10 seconds. The Bluetooth communication module of the license plate number detection device 1 is fixed to scan every 5 seconds for a short period of time, such as 1 second. When the scanning result is that a vehicle enters the second parking space, the first camera immediately takes a picture of the rear license plate of the parked vehicle. Similarly, when there is a vacancy in the (N+1)th parking space, the geomagnetic value decreases, and it is also triggered by Bluetooth to take pictures. The installed recessed parking space sensor can be used to detect the occupancy or vacancy of the parking space.

According to the above-mentioned in-ground parking space sensor, another embodiment of the parking management system of the present invention is characterized in that: comprising a license plate number detection device, an in-ground parking space sensor, and a server; the license plate number detection device includes a first camera, a second camera, and at least one wireless communication module; the in-ground parking space sensor is arranged in the middle of the (N+1)th parking space; the installation method of the license plate number detection device located on the road side parking spaces: The first license plate number detection device and the second license plate number detection device are respectively arranged on the top of the curb next to the Nth and (N+1)th parking spaces, and with a distance of 35-85 cm from the grid line behind the corresponding parking space. With the triggering of the parking space sensor, the first camera of the second license plate number detection device is used to obtain the rear license plate image of the vehicle parked in the (N+1)th parking space, and the second camera of the first license plate number detection device is used to obtain the image of the front license plate of the vehicle on the (N+1)th parking space, and wirelessly upload the shooting time and the shooting image to the server;

The server has a database of the Nth parking space information and the (N+1)th parking space information, and the server receives the parking space image uploaded by the license plate number detection device to determine whether there is a vehicle parked in the Nth parking space or the N+1)th parking space, if there is one, record the license plate number of the vehicle on the parking space to record the parking time and departure time of the vehicle, and record the parking fee calculated according to the parking rate for the license plate number of the parking space. The parking fee is transmitted to the mobile device of the car owner through network communication, so that the mobile device of the car owner can make payment, and at the same time, the database information of the Nth parking space information and the (N+1)th parking space information is updated, so as to facilitate the judgment of other car owners whether there is a car in the Nth parking space and the (N+1)th parking space.

The in-ground parking space sensor is used to detect the occupancy or vacancy of the parking space, and accordingly notify the first camera of the second license plate number detection device through a wireless signal to obtain the image of the rear license plate when the vehicle is reversing into the (N+1)th parking space, and the second camera of the first license plate number detection device obtains the image of the front license plate of the vehicle on the (N+1)th parking space, and uploads the shooting time and the shooting image to the server.

In a certain embodiment, as shown in FIG. 2, a geomagnetic sensor (AMR) 19 may be further installed in the license plate number detection device 1. As a whole, the AMR will change when the vehicle enters and exits the vehicle, which can be used to start taking pictures and reduce the possibility of high power consumption of the camera. For a few parking spaces that are too small or the length of the car is too large, the solution is to start the multi-shot mode. As long as the AMR changes, take a photo. If the two photos uploads to the cloud cannot obtain a recognizable license plate, the billing staff is required to go to take pictures, or take continuous pictures when the car is driving away, to ensure having a recognizable license plate. In case of camera failure or damage, AMR can still be used to determine whether there is a car in the parking space.

In other embodiments, the camera of the license plate number detection device 1 can also be changed to an RFID reader, using the existing ETC data tags (such as RFID tags) on the vehicle to detect the parking space usage status, to obtain vehicle information, including but not limited to the license plate number.

The communication module 184 of FIG. 3 can be any wireless transmission method such as WiFi, LPWAN, Zigbee, Bluetooth, 3G, 4G, 5G, etc., for the data processed (eg encrypted) by the processor CPU, including but not limited to license plate information, vehicle frame information, date, time, etc., are transmitted to the server 2; in addition, in other embodiments, the communication module 184 may include a first communication module and a second communication module, respectively used for the wireless connection server 2 or the license plate number detection device 1 communicates with each other. The following continues to describe the system with server 2.

The server 2 can be set near the parking space 3, for example, a server is configured on one or several road sections, or it can be set in a specific place far away. The server 2 has a database 21 for managing a parking information, the parking 18137241 2023 Jul. 3 information including but not limited to the use status of the parking space, the parking time, the parking section, the parking fee, and the like.

If only the car compartment information is returned, and the license plate information is indistinguishable or is a specific code, it means that the vehicle on this parking compartment has left and is now vacant. At this time, the server 2 can calculate the parking fee of the vehicle that has left is calculated, and the parking space usage status of the parking space in the database 21 is updated. Specifically, if the server 2 has received the corresponding data of the two adjacent parking spaces or the front and rear parking spaces of a specific parking space, but has not received the data of the specific parking space, it means that the specific parking space is now vacant, and the parking fee can be settled accordingly.

As can be seen from the above, the database 21 is dynamically adjusted in real time; users (including but not limited to car owners) can connect to the server 2 through a remote device (computer or mobile phone) to inquire about parking information, including but not limited to the usage status of parking spaces, parking time, parking fees, etc.

Similarly, the server 2 can also output information including but not limited to license plate information, vehicle frame information, parking date, parking time, parking section and other information to the mobile device of the vehicle owner for the vehicle owner's reference and payment.

Further, in another derivative embodiment, the scheme can be, for example:
1. The car owner can connect with the server 2 through the App, mobile wallet, third-party payment or existing payment website to obtain parking information, and make online or physical payment after confirmation.
2. The server 2 actively informs the car owner; the server 2 can know the car owner's contact information through the parking information comparison database 21 or an external database, and then notify the car owner through means such as text messages, e-mail, APP, etc. The car owner can use this information to pay the fee on the relevant website or go to a specific place to pay the fee with the barcode in the APP; or, the server 2 can notify the third-party manufacturer to pay the payment operator, and then the operator can confirm with the car owner or obtain the car owner's authorization in advance to make online payment. In addition, this move also has the effect of preventing theft; in detail, when the car owner receives the server 2 informing him of the parking fee after the settlement of the vehicle, it means that the parking management system judges that the car owner's vehicle has left. The fact that the owner did not actually leave the vehicle means that the vehicle may have been stolen or mistakenly towed.

The server 2 in this embodiment is an existing server of a transportation agency, or an independent server connected to the server of a transportation agency, but this example is not limited to this. In other embodiments, the server 2 can be further connected with other information servers (not shown) for data sharing; in this way, the server 2 can not only provide services for querying and informing parking information, but also provide inquiry and notification of other additional information; among them, traffic information includes but not limited to ticket information, regular vehicle inspection information, vehicle tax payment information, ETC information, etc.; other additional information includes but not limited to the vehicle to which the license plate belongs and the vehicle owner's name related other information.

Of course, the server 2 can also actively or passively share relevant information to other agencies, such as stolen vehicles, abnormal license plates (for example, multiple vehicles with the same license plate are registered at the same time) and other information.

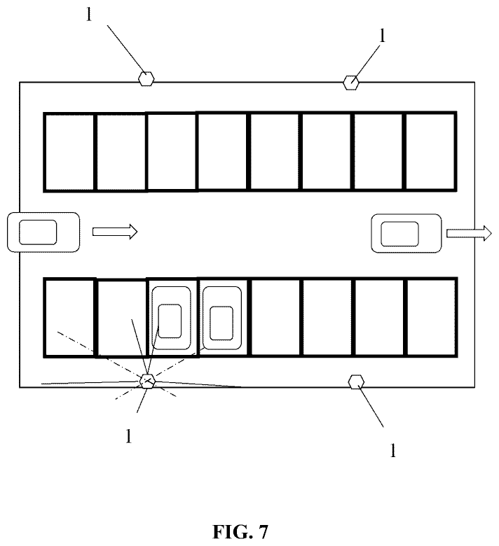

Further, in another derivative embodiment, a parking management system is characterized in that: it includes a license plate number detection device and a server; the license plate number detection device includes a first camera and a second camera, at least one wireless communication module; the license plate number detection device is installed in an open parking lot, a gateless parking lot, and a small parking lot: As shown in FIG. 7, the license plate number detection device 1 is arranged in every 4 parking spaces. The middle wall or fence is set above a low wall (not shown) similar to the height of the curb, so that the first camera can shoot the two parking spaces on the left, and the second camera can shoot the two parking spaces on the right. Shoot the license plate images of the four parking spaces at regular intervals, and wirelessly upload the shooting time and the shot images to the server; the server has a database of the four parking spaces, and the server receives the parking space image uploaded by the license plate number detection device to determine whether there is a vehicle parked in the four parking spaces, and if so, record the license plate number of the vehicle on the parking space to record the parking time and departure time of the vehicle, and the record is based on the parking record to calculate the parking fee of the license plate number of the parking space at a rate, transmit the parking fee to the mobile device of the car owner through network communication, so that the mobile device of the car owner can make payment, and update the database information of the four-parking space information, so as to facilitate other car owners judge whether there are cars in the four parking spaces. Taking the example shown in FIG. 7, if 16 cars are parked, only 4 license plate number detection devices 1 are needed, and the required cost is NT$50,000 to start operation.

In addition, the terms “first” and “second” are only used for descriptive purposes, and cannot be understood as indicating or implying relative importance or implying the number of indicated technical features. Thus, a feature defined as “first” or “second” may expressly or implicitly include one or more of that features. In the description of the present invention, “plurality” means two or more, unless otherwise expressly and specifically defined.

In the present invention, unless otherwise expressly specified and limited, terms such as “installation”, “connected”, “fixed” should be understood in a broad sense, for example, it may be a fixed connection or a Removable connection, or integrated; it can be mechanical connection or electrical connection; it can be directly connected or indirectly connected through an intermediate medium, it can be the internal communication between two elements or the interaction relationship between the two elements. For those of ordinary skill in the art, the specific meanings of the above terms in the present invention can be understood according to specific situations.

In the present invention, unless otherwise expressly specified and limited, the first feature “on” or “under” the second feature may include the first and second features in direct contact, and may also include the first and second features. The second feature is not in direct contact but is in contact through another feature between them. Also, the first feature being “above”, “on” and “over” the second feature includes the first feature being directly above and obliquely above the second feature, or simply means that the first feature level is higher than the second feature. The first feature being “below”, and “under” the second feature includes that the first feature is directly and diagonally below the second feature, or simply means that the first feature has a lower level than the second feature.

In the description of this specification, reference to the terms “one embodiment,” “some embodiments,” “example,” “specific example,” or “some examples” or the like is intended to be described in conjunction with the embodiment or example. The specific features, structures, materials or characteristics of the present invention are included in at least one embodiment or example of the present invention. In this specification, schematic representations of the above terms should not be construed as necessarily referring to the same embodiment or example. Furthermore, the particular features, structures, materials or characteristics described may be combined in any suitable manner in any one or more embodiments or examples. Furthermore, those skilled in the art may combine and combine the different embodiments or examples described in this specification.

Although the embodiments of the present invention have been shown and described above, it is to be understood that the above embodiments are exemplary and should not be construed as limiting the present invention, and those of ordinary skill in the art may make-modifications, substitutions and variations to the above-described embodiments within the scope of the present invention.

What is claimed is:

1. A parking management system comprising of
at least two license plate number detection devices and a server; the license plate number detection device includes at least one parking space sensor, a first camera and a second camera, which are connected with a processing module and a wireless communication module respectively; the installation method in roadside parking spaces as follows: the first license plate number detection device and the second license plate number detection device are respectively installed on the top of the curb next to the Nth and (N+1)th parking spaces, and at the distance of 35-85 cm before the rear gridline of the corresponding parking space; with the triggering of the parking space sensor, the first camera of the second license plate number detection device is used to obtain the rear license plate image of the vehicle parked in the (N+1) parking space; further, through the notification of wireless communication, the second camera of the first license plate number detection device is used to obtain the image of the front license plate of the vehicle on the (N+1)th parking space, and wirelessly upload the shooting time and the shooting image to the server;
the server has a database of the Nth parking space information and the (N+1)th parking space information, and the server receives the parking space image uploaded by the license plate number detection device to determine whether there is a vehicle parked in the Nth parking space or the (N+1)th parking space; if yes, record the license plate number of the vehicle on the parking space, the parking time and departure time of the vehicle, then transmit to the mobile device of the vehicle owner through network communication, so that the mobile device of the vehicle owner can make payment, and the database information of the first parking space information and the (N+1)th parking space information is updated at the same time, let other vehicle owners check whether there is a vehicle in the the Nth or (N+1)th parking space.

2. The parking management system of claim 1, wherein the parking space sensor comprises a geomagnetic sensor, and at least one ranging sensor; the ranging sensor is selected from ultrasonic, infrared, microwave, radar, LiDAR sensors.

3. The parking management system according to claim 2, wherein when the geomagnetic sensor of the license plate number detection device of the (N+1)th parking space does not detect enough steady-state geomagnetic value, it can be determined that there is no vehicle parked in the (N+1) parking space; in this way, the ranging sensor detect for one second every 5 seconds, and the detection distance is about 2-3 meters to confirm whether there is a vehicle reversing to park, if yes, start the first camera to take a picture of the rear license plate of the parked vehicle, and stop the operation of the ranging sensor at the same time; after the vehicle is parked, the geomagnetic sensor detects that there is a sufficient steady state to determine that the vehicle has been parked properly; further, the second camera is activated through the Bluetooth connection to the license plate number detection device of the Nth parking space to take a picture of the front license plate of the vehicle parked in the (N+1)th parking space.

4. The parking management system according to claim 1, wherein the wireless communication module is selected from Bluetooth, WIFI, LPWA, 3G, 4G or 5G, and to communicate with the owner's mobile phone.

5. The parking management system according to claim 1, wherein there are multiple license plate number detection devices, and each parking space is provided with a license plate number detection device, which is located at the distance of 35-85 cm before the rear gridline of the corresponding parking space; an extra license plate number detection device is installed at a distance of 35-85 cm before the front gridline of the head end parking space.

6. The parking management system according to claim 1, wherein the license plate number detection device is installed on the side of the road through a pile, or installed directly above the curb, or manufactured into the shape of the curb to replace part of the curb, the height of the first camera and the second camera is 10-30 cm above the ground.

7. The parking management system according to claim 1, wherein the license plate number detection device comprises a cover, a base, a support frame, a wireless communication module, a parking space sensor, a first camera, and a second camera, battery, solar panel and processing module, the upper cover is connected with the base, the support frame is arranged on the upper cover, the battery is connected with the solar panel, the solar panel is arranged between the support frame and the upper cover, and supplies power to the battery, and the processing module is arranged in between the support frame and the upper cover, the processing module is connected with the parking space sensor, the wireless communication module, the first camera and the second camera.

8. A parking management system, comprising of
at least two license plate number detection devices, an in-ground parking space sensor, and a server; the license plate number detection device includes a first camera, a second camera, and at least one wireless communication module; the in-ground parking space sensor is arranged in the middle of the (N+1)th parking space; the installation method of the license plate number detection device in the roadside parking space as follows: the first license plate number detection device and the second license plate number detection device is respectively arranged above the curb next to the Nth and (N+1)th parking spaces, and is 35-85 cm away from the rear gridline of the corresponding parking space; with the triggering of the in-ground parking space sensor, the first camera of the second license plate number detection device is used to obtain the rear license plate image of the vehicle parked in the (N+1)th parking space, and the second camera of the first license plate number detection device is used to obtain the image of the front license plate of the vehicle on the (N+1)th parking space, and wirelessly upload the shooting time and shooting image to the server;
the server has a database of the Nth parking space information and the (N+1)th parking space information, and the server receives the parking space image uploaded by the license plate number detection device to determine whether there is a vehicle parked in the Nth parking space or the (N+1)th parking space; if yes, record the license plate number of the vehicle on the parking space, the parking time and departure time of the vehicle, then transmit to the mobile device of the vehicle owner through network communication, so that the mobile device of the vehicle owner can make payment, and the database information of the first parking space information and the (N+1)th parking space information is updated at the same time, let other vehicle owners check whether there is a vehicle in the the Nth or (N+1)th parking space.

9. The parking management system as claimed in claim 8, wherein the in-ground parking space sensor is used to detect the occupied space or vacant space of the vehicle compartment, and accordingly notify the second license plate number detection through a wireless signal; the first camera of the detection device obtains the rear license plate image of the vehicle parked in the (N+1)th parking space when it reverses to park, start the first camera to take a picture of the rear license plate of the parked vehicle; after the vehicle is parked, the geomagnetic sensor detects that there is a sufficient steady state to determine that the vehicle has been parked properly; further, the second camera is activated through the Bluetooth connection to the license plate number detection device of the Nth parking space to take a picture of the front license plate of the vehicle parked in the (N+1)th parking space.

10. The parking management system according to claim 8, wherein the license plate number detection device comprises a cover, a base, a support frame, a wireless communication module, a first camera, a second camera, a battery, and a solar panel and processing module, the upper cover is connected with the base, the support frame is arranged on the upper cover, the battery is connected with the solar panel, the solar panel is arranged between the support frame and the upper cover, and supplies power to the battery, and the processing module is arranged between the support frame and the upper cover In between, the processing module is connected with the wireless communication module, the first camera and the second camera.

11. The parking management system according to claim 8, wherein there are multiple license plate number detection devices, and each parking space is provided with a license plate number detection device, which is located at the distance of 35-85 cm before the rear gridline of the corresponding parking space; an extra license plate number detection device is installed at a distance of 35-85 cm before the front gridline of the head end parking space.

12. The parking management system according to claim 8, wherein the license plate number detection device is installed on the side of the road through a pile, or installed directly above the curb, or manufactured into the shape of the curb to replace part of the curb, the height of the first camera and the second camera is 10-30 cm above the ground.

13. A parking management system, comprising of
a license plate number detection device and a server; the license plate number detection device includes a first camera and a second camera, and at least one wireless communication module; the license plate number detection device is installed in open parking lot, non-gate parking lot, and small parking lot; the license plate number detection device is installed on the wall or fence in the middle of every 4 parking spaces, the first camera shoots the two parking spaces on the left, and the second camera shoots the two parking spaces on the right, then the shooting time and images are wirelessly uploaded to the server;
the server has a database of the information of the four parking spaces, and the server receives the parking space images uploaded by the license plate number detection device to determine whether there is a vehicle parked in the four parking spaces, and if so, record the license plate number of the vehicle on the parking space, the parking time and departure time of the vehicle, record the parking fee calculated according to the parking rate for the license plate number of the parking space, and transmit the parking fee to the mobile device of the vehicle owner via network communication, so as to facilitate the mobile device of the vehicle owner to make the payment, and the database information of the four parking spaces is updated at the same time, so that other vehicle owners can judge whether there are vehicles in the four parking spaces.

14. The parking management system according to claim 13, wherein the license plate number detection device includes a cover, a base, a support frame, a wireless communication module, a first camera, a second camera, a battery, and a solar panel, and processing module, the upper cover is connected with the base, the support frame is arranged on the upper cover, the battery is connected with the solar panel, the solar panel is arranged between the support frame and the upper cover, and supplies power to the battery, and the processing module is arranged between the support frame and the upper cover In between, the processing module is connected with the wireless communication module, the first camera and the second camera.
